(19) United States
(12) Patent Application Publication
(10) Pub. No.: US 2025/0004445 A1
(43) Pub. Date: Jan. 2, 2025

(54) NUMERICAL CONTROL SYSTEM

(71) Applicant: FANUC CORPORATION, Yamanashi (JP)

(72) Inventor: Ryou NAKAMURA, Yamanashi (JP)

(73) Assignee: FANUC CORPORATION, Yamanashi (JP)

(21) Appl. No.: 18/560,705

(22) PCT Filed: Jun. 25, 2021
(86) PCT No.: PCT/JP2021/024109

§ 371 Date: Jul. 16, 2024

(51) Int. Cl. G05B 19/4155; B23Q 15/12

(52) U.S. Cl. CPC G05B 19/4155; B23Q 15/12; G05B 2219/50319; G05B 2219/50391

(57) ABSTRACT

A numerical control system 1 is provided with N numerical control devices 5_1, . . . for controlling the operation of a machine tool on the basis of a numerical control program, and generating a robot command, and a robot control device 6 for controlling the operation of a robot 3 on the basis of a robot command. Each numerical control device is provided with a communication interface 56_1, . . . for transmitting to the robot control device 6 a request for connecting to the robot control device 6, and the robot control device 6 is provided with a robot connection reply unit 63 for generating a connection approval with respect to connection request after a connection request has been received by a communication interface 60, and a robot connection determination unit 64 for selecting one of the plurality of numerical control devices as a connection approval transmission destination. The communication interface 60 transmits the connection approval to the communication interface of the connection approval transmission destination, and the communication interface of each numerical control device begins transmitting a robot command to the communication interface 60 after receipt of the connection approval.

### TECHNICAL FIELD

The present disclosure relates to a numerical control system.

### BACKGROUND ART

In general, the programming languages differ between the numerical control programs for controlling machine tools and the robot programs for controlling robots. Therefore, in order to operate machine tools and robots concurrently, an operator needs to be proficient in both the numerical control programs and the robot programs.

Patent Document 1 discloses a numerical control device that controls both machine tools and robots through a numerical control program. According to the numerical control device of Patent Document 1, an operator familiar with numerical control programs can control robots without mastering robot programs.

Patent Document 1: Japanese Patent No. 6647472

### DISCLOSURE OF THE INVENTION

### Problems to be Solved by the Invention

Patent Document 1 discloses a technology for operating one robot and one machine tool concurrently; however, in actual factories, there may be situations where one robot and a plurality of machine tools are operated concurrently. With such a configuration, in order to perform communication between the robot control device that directly controls the operation of the robot and the plurality of numerical control devices that control the machine tools, the robot control device needs to secure a communication interface having the capacity of the number of numerical control devices. In other words, the number of numerical control devices connectable to one robot control device is limited by the size of the communication interface of the robot control device.

In such a case where one robot control device is provided with the communication interface having the capacity of the number of numerical control devices, while the robot control device is controlling the operation of the robot, based on commands transmitted from a certain numerical control device, other numerical control devices need to constantly check whether the operation of the robot has been completed, through communication. Therefore, the robot control device may bear a communication burden proportional to the number of numerical control devices, which may potentially reduce the operational performance of the robot.

Note that there exist numerical control devices that can concurrently control the operation of a plurality of machine tools through a plurality of control modules. In order to perform communication between the numerical control device and the robot control device as such, the robot control device needs to secure a communication interface having the capacity of the number of control modules. Therefore, the above-mentioned problems can also occur when one robot control device is connected to one numerical control device.

The present disclosure has been made in view of the above-mentioned problems, and provides a numerical control system including a robot control device that controls robot operations, based on robot commands generated by the numerical control program in the control module of the numerical control device, in which the number of numerical control devices connected to the robot control device or the number of their control modules can be changed regardless of the size of the communication interface of the robot control device. Means for Solving the Problems

One aspect of the present disclosure is a numerical control system, including: a numerical control device that controls an operation of a machine tool, based on a numerical control program; and a robot control device that controls an operation of a robot, based on a robot command, in which the numerical control device includes one or more control modules that generate the robot command, based on the numerical control program; the control modules each include: a robot command generation unit that generates the robot command, based on the numerical control program; a robot connection request unit that generates a connection request to the robot control device; and a command-transmitting communication interface that transmits the connection request and the robot command to the robot control device; and the robot control device includes: a command-receiving communication interface that receives the connection request and the robot command; a robot operation control unit that controls the operation of the robot, based on the robot command; and a robot connection response unit that generates a connection approval for the connection request, after the connection request is received by the command-receiving communication interface, in which the command-receiving communication interface transmits the connection approval to the command-transmitting communication interface, and the command-transmitting communication interface starts transmission of the robot command to the command-receiving communication interface after receiving the connection approval.

### Effects of the Invention

According to one aspect of the present disclosure, if the operator is familiar with the numerical control program used for controlling the machine tool, the operator can also control the robot without mastering the robot program described in a different language. According to one aspect of the present disclosure, the command-transmitting communication interface of the numerical control device receives a connection approval generated by the robot connection response unit of the robot control device in response to a connection request generated by the robot connection request unit of the numerical control device, and thereafter starts transmitting a robot command generated by the robot command generation unit to the command-receiving communication interface. In other words, the timing to start transmitting a robot command from the numerical control device side to the robot control device side can be managed by the robot control device side in accordance with the connection request transmitted from the numerical control device side. Therefore, according to one aspect of the present disclosure, robot commands from a plurality of command-transmitting communication interfaces can be received by sharing one command-receiving communication interface. Therefore, according to one aspect of the present disclosure, the number of numerical control devices connected to the robot control device and the number of their control modules can be changed regardless of the size of the command-receiving communication interface of the robot control device. According to one aspect of the present disclosure, for example, while the robot control device is controlling the operation of the robot, based on the robot command transmitted from a certain numerical control device, the other numerical control devices do not need to constantly check whether the operation of the robot has been completed, through communication; therefore, even if the number of connected numerical control devices increases, the communication load on the robot control device will not increase, allowing for preventing the deterioration of the operational performance of the robot.

### BRIEF DESCRIPTION OF THE DRAWINGS

FIG. 1 is a schematic diagram of a numerical control system according to a first embodiment of the present disclosure;

FIG. 2A is a functional block diagram of a first numerical control device and an N-th numerical control device;

FIG. 2B is a functional block diagram of a robot control device;

FIG. 3A is a first example of a first numerical control program;

FIG. 3B is a first example of the N-th numerical control program;

FIG. 4 is a sequence diagram illustrating the flow of signals and information between the first and N-th numerical control devices and the robot control device when the first and N-th numerical control devices are operated based on the first example of the numerical control program;

FIG. 5A is a second example of the first numerical control program;

FIG. 5B is a second example of the N-th numerical control program;

FIG. 6 is a sequence diagram illustrating the flow of signals and information between the first and N-th numerical control devices and the robot control device when the first and N-th numerical control devices are operated based on the second example of the numerical control program;

FIG. 7A is a third example of the first numerical control program;

FIG. 7B is a third example of the N-th numerical control program;

FIG. 8 is a sequence diagram illustrating the flow of signals and information between the first and N-th numerical control devices and the robot control device when the first and N-th numerical control devices are operated based on the third example of the numerical control program;

FIG. 9 is a diagram comparing the overall system cycle times between a conventional numerical control system and the numerical control system according to the embodiment, in a case where two numerical control devices are connected to one robot control device; and

FIG. 10 is a functional block diagram of a numerical control system according to a second embodiment of the present disclosure.

### PREFERRED MODE FOR CARRYING OUT THE INVENTION

### First Embodiment

Hereinafter, referring to the drawings, a numerical control system 1 according to a first embodiment of the present disclosure will be described.

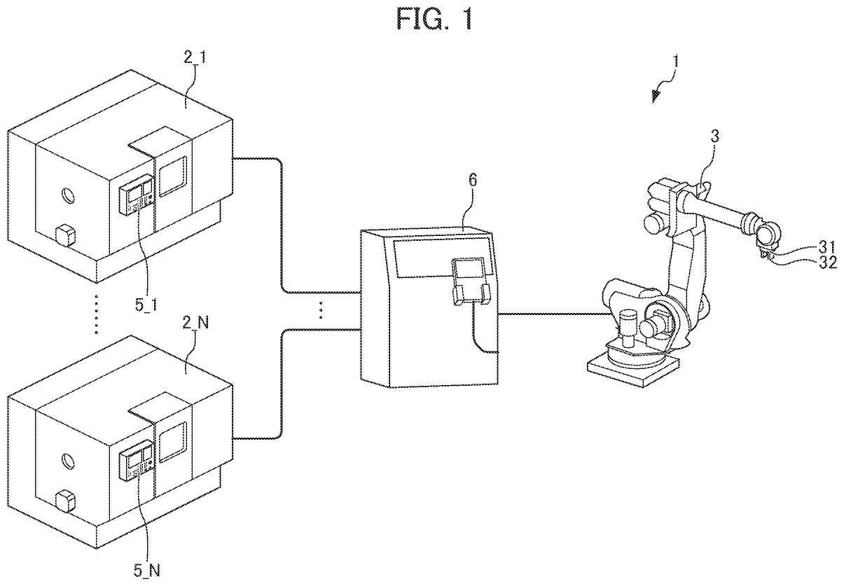

FIG. 1 is a schematic diagram of the numerical control system 1 according to the present embodiment.

The numerical control system 1 includes: a plurality (N units, where N is an integer equal to or greater than 2 in the present embodiment) of machine tools 2_1, . . . , and 2_N; a plurality (the same N units as the machine tools in the present embodiment) of numerical control devices 5_1, . . . , and 5_N that control the operation of the machine tools 2_1, . . . , and 2_ N, respectively; a robot 3 provided near the machine tools 2_1, . . . , and 2_N; and a robot control device 6 that is communicably connected to the numerical control devices 5_1, . . . , and 5_N. Note that the drawings and detailed descriptions of the 2nd to N−1st machine tools and numerical control devices will be omitted, among the N machine tools 2_1, . . . , and 2_N, and the N numerical control devices 5_1, . . . , and 5_N.

Note that the present embodiment describes the case where the N numerical control devices 5_1, . . . , and 5_N are communicably connected to one robot control device 6; however, the present disclosure is not limited to this. The number of numerical control devices connected to the robot control device may be one, as described later in a third embodiment.

The first numerical control device 5_1, which is the first among N numerical control devices, generates a first machine tool control signal for the first machine tool 2_1, which is the first among N machine tools, and a first robot command for the robot 3, in accordance with a predetermined first numerical control program, and transmits the first machine tool control signal and the first robot command to the first machine tool 2_1 and the robot control device 6, respectively.

The N-th numerical control device 5_N, which is the N-th among N numerical control devices, generates an N-th machine tool control signal for the N-th machine tool 2_N, which is the N-th among N machine tools, and an N-th robot command for the robot 3 in accordance with a predetermined N-th numerical control program, and transmits the N-th machine tool control signal and the N-th robot command to the N-th machine tool 2_N and the robot control device 6, respectively.

The robot control device 6 controls the operation of the robot 3 in response to the robot commands transmitted from the numerical control devices 5_1, . . . , and 5_N, respectively.

The machine tools 2_1, . . . , and 2_N machine the workpieces (not illustrated) in response to machine tool control signals transmitted from the numerical control devices 5_1, . . . , and 5_N, respectively. Here, the machine tools 2_1, . . . , and 2_N are, for example, lathes, drilling machines, milling machines, grinding machines, laser beam machines, and injection molding machines; however, this is not limiting.

The robot 3 operates under the control of the robot control device 6, and for example, performs a predetermined task on a workpiece that has been machined by the machine tools 2_1, . . . , and 2_N. The robot 3, for instance, is a multi-joint robot, in which a gripping tool 32 for gripping a workpiece is attached to the tip of an arm 31. The following describes the case where the robot 3 uses the gripping tool 32 to grip a workpiece at a predetermined position, in which the workpiece has been machined by the machine tools 2_1, . . . , and 2_N, and transports the workpiece to another predetermined position; however, this is not limiting. The following describes the case where the robot 3 is a 6-axis multi-joint robot; however, the number of axes is not limited to this.

The numerical control devices 5_1, . . . , and 5_N, and the robot control device 6 are computers, which are configured with hardware such as: arithmetic processing means such as CPU (Central Processing Unit); auxiliary storage means such as HDD (Hard Disk Drive) or SSD (Solid State Drive) for storing various programs; main storage means such as RAM (Random Access Memory) for storing data temporarily required when the arithmetic processing means executes the programs; operation means such as a keyboard for the operator to perform various operations; and display means such as a display for displaying various information for the operator. The robot control device 6 and the numerical control devices 5_1, . . . , and 5_N can send and receive various signals to and from each other, for example, via Ethernet (registered trademark).

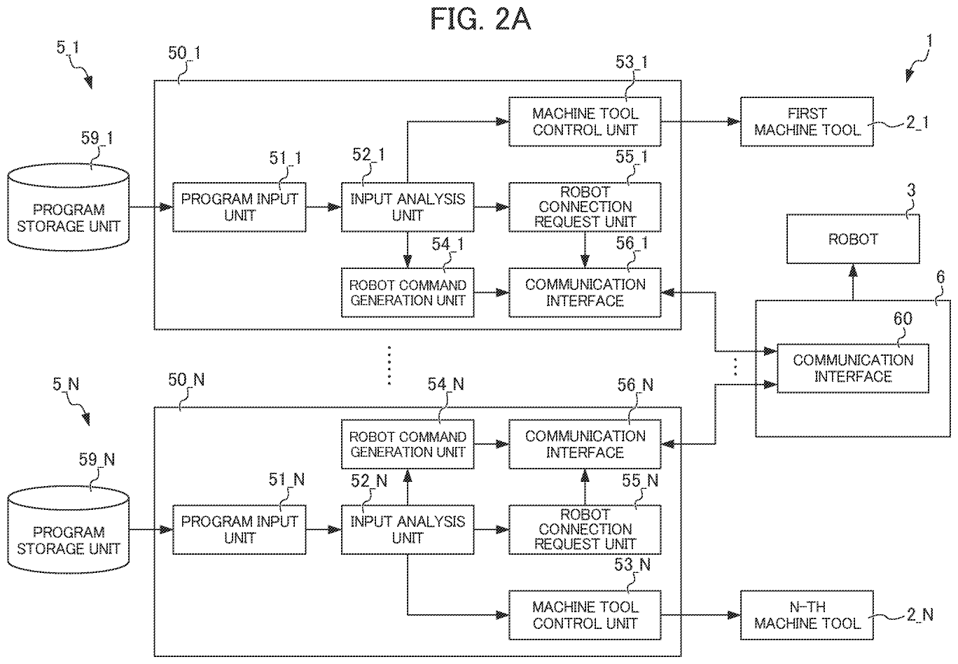

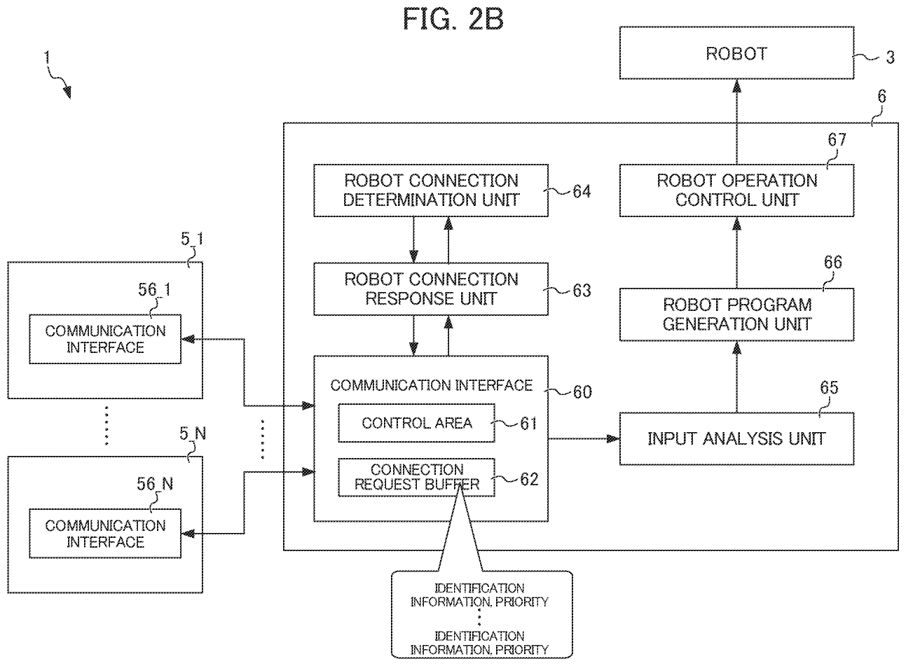

FIG. 2A is a functional block diagram of the first numerical control device 5_1 and the N-th numerical control device 5_N; and FIG. 2B is a functional block diagram of the robot control device 6. The following describes the detailed configuration of the numerical control devices 5_1, 5_N at first, and the detailed configuration of the robot control device 6 next.

As illustrated in FIG. 2A, the first numerical control device 5_1 includes various functions such as a control module 50_1 serving as the control system for the first machine tool 2_1 and the robot 3, a program storage unit 59_1, etc., which are implemented by the above-mentioned hardware configuration. Note that the following describes the case where the first numerical control device 5_1 includes the control module 50_1 for controlling the operations of both the first machine tool 2_1 and the robot 3; however, the present disclosure is not limited to this. A machine-tool control module for controlling the operation of the first machine tool 2_1 and another control module for controlling the operation of the robot 3 may be separately provided to the first numerical control device 5_1.

The program storage unit 59_1 stores a plurality of first numerical control programs, for example, created based on the operation by the operator. More specifically, the program storage unit 59_1 stores a first numerical control program, which is configured with a plurality of command blocks for controlling the operation of the first machine tool 2_1, and a plurality of command blocks for controlling the operation of the robot 3. The first numerical control program stored in the program storage unit 59_1 is described in a known programming language such as G-code or M-code. Note that the following describes the case where the first numerical control program includes command blocks for the first machine tool 2_1 and command blocks for the robot 3; however, the present disclosure is not limited to this. The command blocks for the first machine tool 2_1 and the command blocks for the robot 3 may be described in different numerical control programs.

In the first numerical control program stored in the program storage unit 59_1, the command blocks for the first machine tool 2_1 are described based on the first machine tool coordinate system with the reference point determined on or near the first machine tool 2_1 as the origin. That is, in the first numerical control program, the position of the control point, the posture, etc. of the first machine tool 2_1 are described by coordinate values in the first machine tool coordinate system.

In the first numerical control program stored in the program storage unit 59_1, the command blocks for the robot 3 are described based on the robot coordinate system different from the first machine tool coordinate system mentioned above. That is, in the first numerical control program, the position of the control point and the posture of the robot 3 (for example, the tip of the arm 31 of the robot 3) are described by coordinate values in the robot coordinate system different from the first machine tool coordinate system. The robot coordinate system is the coordinate system with the reference point determined on or near the robot 3 as the origin. Note that the following describes the case where the robot coordinate system is different from the first machine tool coordinate system; however, the present disclosure is not limited to this. The robot coordinate system may coincide with the first machine tool coordinate system. In other words, the origin and the coordinate axis direction of the robot coordinate system may coincide with the origin and the coordinate axis direction of the first machine tool coordinate system.

In the first numerical control program, the robot coordinate system can switch between two or more coordinate formats with different control axes. More specifically, in the first numerical control program, the position of the control point and the posture of the robot 3 can be specified in the Cartesian coordinate format or the joint coordinate format.

In the joint coordinate format, the position of the control point and the posture of the robot 3 are specified by six real coordinate values consisting of rotation angle values of the six joints of the robot 3 (J1, J2, J3, J4, J5, J6).

In the Cartesian coordinate format, the position of the control point and the posture of the robot 3 are specified by six real coordinate values consisting of three coordinate values (X, Y, Z) along the three Cartesian coordinate axes, and three rotation angle values (A, B, C) around the respective Cartesian coordinate axes.

Under the joint coordinate format, the rotation angles of the joints of the robot 3 can be directly specified; therefore, the axial arrangement of the arm and wrist of the robot 3, and the rotation number of the joint that can rotate more than 360 degrees (hereinafter collectively referred to as the “configuration of the robot 3”) are also uniquely defined. On the other hand, under the Cartesian coordinate format, the position of the control point and the posture of the robot 3 are specified by six coordinate values (X, Y, Z, A, B, C); therefore, the configuration of the robot 3 cannot be uniquely defined. Therefore, in the first numerical control program, the configuration of the robot 3 can be specified by a configuration value P, which is an integer of a predetermined number of digits. Thus, the position of the control point, the posture, and the configuration of the robot 3 are represented by six coordinate values (J1, J2, J3, J4, J5, J6) under the joint coordinate format, or by six coordinate values and one configuration value (X, Y, Z, A, B, C, P) under the Cartesian coordinate format. Note that the configuration value P is hereinafter also referred to as a coordinate value, for convenience.

In the first numerical control program, the coordinate format can be set by using the G-codes “G68.8” and “G68.9”. More specifically, the coordinate format is set to the joint coordinate format by inputting the G-code “G68.8”, and the coordinate format is set to the Cartesian coordinate format by inputting the G-code “G68.9”. The G-codes “G68.8” and “G68.9” for setting these coordinate formats are modal. Therefore, once the coordinate format is set to either the joint coordinate format or the Cartesian coordinate format by the G-codes, the coordinate format will be maintained until the coordinate format is changed again by the G-codes. Note that in the present embodiment, when the G-codes for setting these coordinate formats are not described in the first numerical control program, the coordinate format will be automatically set to the Cartesian coordinate format; however, this is not limiting.

The control module 50_1 includes a program input unit 51_1, an input analysis unit 52_1, a machine tool control unit 53_1, a robot command generation unit 54_1, a robot connection request unit 55_1, and a communication interface 56_1; the control module 50_1 use them to control the operation of the first machine tool 2_1, and generates the first robot command for controlling the operation of the robot 3, based on the first numerical control program.

The program input unit 51_1 reads a predetermined first numerical control program from the program storage unit 59_1, and sequentially inputs the program to the input analysis unit 52_1.

The input analysis unit 52_1 analyzes the type of command for each command block, based on the first numerical control program that is inputted from the program input unit 51_1, and transmits the analysis result to the machine tool control unit 53_1, the robot command generation unit 54_1, and the robot connection request unit 55_1. More specifically, if the type of command of the command block is a command for the first machine tool 2_1, the input analysis unit 52_1 transmits it to the machine tool control unit 53_1; if the type of command of the command block is a command for the robot 3, the input analysis unit 52_1 transmits it to the robot command generation unit 54_1; and if the type of command of the command block is a request to the robot control device 6, the input analysis unit 52_1 transmits it to the robot connection request unit 55_1.

The machine tool control unit 53_1 generates the first machine tool control signal for controlling the operation of the first machine tool 2_1 in accordance with the analysis result of the first numerical control program transmitted from the input analysis unit 52_1, and inputs the signal to the actuator that drives the various axes of the first machine tool 2_1. The first machine tool 2_1 operates in response to the first machine tool control signal that is inputted from the machine tool control unit 53_1, and machines a workpiece (not illustrated).

The robot connection request unit 55_1 generates a connection request or a disconnection request to the robot control device 6, based on the analysis result of the first numerical control program transmitted from the input analysis unit 52_1. More specifically, the connection request to the robot control device 6 refers to asking the robot control device 6 for permission to transmit the first robot command from the communication interface 56_1 of the first numerical control device 5_1 to the communication interface 60 (described later) of the robot control device, such that the operation of the robot 3 can be controlled based on the first robot command generated by the robot command generation unit 54_1 (described later), based on the first numerical control program. More specifically, the disconnection request to the robot control device 6 refers to notifying the robot control device 6 that the transmission of the first robot command from the communication interface 56_1 to the communication interface 60 is terminated, such that the control of the operation of the robot 3 is terminated based on the first robot command.

In the first numerical control program, a connection request to the robot connection request unit 55_1 can be generated by the G code “G200”, and a disconnection request to the robot connection request unit 55_1 can be generated by the G code “G201”. In the first numerical control program, a priority value for the connection request can be specified by describing the priority specification command “P_” following the G code “G200”. Note that the underscore in the above priority specification command is filled with any integer value of 1 or more, as a value indicating the level of priority. In the following, the higher the priority value, the higher the priority; however, the present disclosure is not limited to this. The smaller the priority value, the higher the priority may be.

When the robot connection request unit 55_1 generates a connection request, based on the first numerical control program through the process as described above, the robot connection request unit 55_1 writes the generated connection request and the connection request information associated with this connection request into the communication interface 56_1, and transmits the connection request and the connection request information to the robot control device 6. The connection request information includes identification information (for example, the IP address unique to the first numerical control device 5_1) for identifying the first numerical control device 5_1, which is the sender of the connection request, on the robot control device 6 side, and the priority value specified based on the above-mentioned priority specification command.

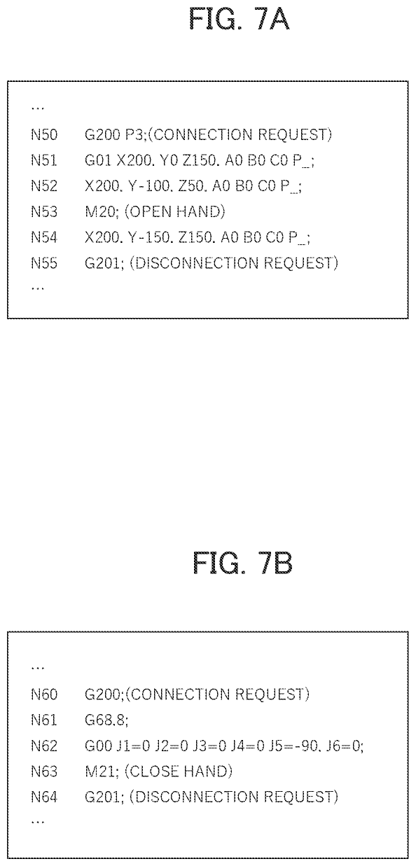

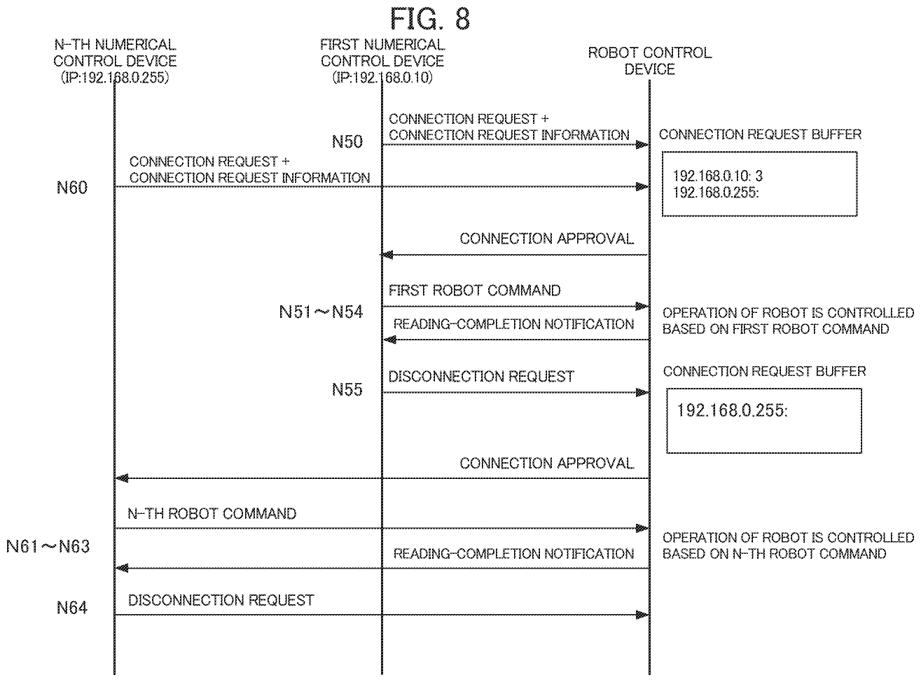

Note that the present embodiment describes the case in which, when a priority value for the connection request is not specified by the first numerical control program, namely when the priority specification command is not described in the first numerical control program, the robot connection request unit 55_1 writes a predetermined initial value as the priority value into the communication interface 56_1, and transmits the value to the robot control device 6; however, the present disclosure is not limited to this. As described later with reference to FIGS. 7B and 8, when a priority value for the connection request is not specified by the first numerical control program, the robot connection request unit 55_1 may transmit only the identification information to the robot control device 6 without transmitting a priority value.

When the robot connection request unit 55_1 generates a disconnection request, based on the first numerical control program through the process as described above, the robot connection request unit 55_1 writes the generated disconnection request into the communication interface 56_1, and transmits the disconnection request to the robot control device 6.

The robot command generation unit 54_1 generates the first robot command for moving the control axis of the robot 3, based on the analysis result of the first numerical control program transmitted from the input analysis unit 52_1, writes the generated robot command into the communication interface 56_1, and transmits the robot command to the robot control device 6. Note that the following describes the case where the command for the robot 3 is a command block between the G code “G200” for generating a connection request to the robot connection request unit 55_1 and the G code “G201” for generating a disconnection request to the robot connection request unit 55_1, in the first numerical control program; however, the present disclosure is not limited to this.

The robot command generation unit 54_1 confirms that the connection approval (described later), which is transmitted from the robot control device 6 in response to the connection request generated by the robot connection request unit 55_1, is received by the communication interface 56_1 as described above, then starts generating the first robot command, based on the first numerical control program, and transmitting the first robot command to the robot control device 6 side, as described above.

When the connection request and the connection request information are written by the robot connection request unit 55_1, the communication interface 56_1 transmits the connection request and the connection request information to the communication interface 60 of the robot control device 6. When the disconnection request is written by the robot connection request unit 55_1, the communication interface 56_1 transmits the disconnection request to the communication interface 60.

When the communication interface 56_1 receives a connection approval transmitted from the robot control device 6 in response to the connection request through the process described below, the communication interface 56_1 notifies the robot command generation unit 54_1 of the receipt of the connection approval. After receiving the connection approval, when the first robot command is written by the robot command generation unit 54_1 as described above, the communication interface 56_1 transmits the first robot command to the communication interface 60.

Note that the control target of the N-th numerical control device 5_N is the N-th machine tool 2_N, which is the difference from the first numerical control device 5_1; however, the other configurations are almost the same as those of the first numerical control device 5_1, so the detailed description of the configuration of the N-th numerical control device 5_N will be omitted below. That is, the N-th numerical control device 5_N includes: a program storage unit 59_N that stores a plurality of N-th numerical control programs; a control module 50_N having a configuration almost the same as the control module 50_1 of the first numerical control device 5_1; a program input unit 51_N having a configuration almost the same as the program input unit 51_1 of the first numerical control device 5_1; an input analysis unit 52_N having a configuration almost the same as the input analysis unit 52_1 of the first numerical control device 5_1; a machine tool control unit 53_N having a configuration almost the same as the machine tool control unit 53_1 of the first numerical control device 5_1; a robot command generation unit 54_N having a configuration almost the same as the robot command generation unit 54_1 of the first numerical control device 5_1; a robot connection request unit 55_N having a configuration almost the same as the robot connection request unit 55_1 of the first numerical control device 5_1; and a communication interface 56_N having a configuration almost the same as the communication interface 56_1 of the first numerical control device 5_1.

Next, referring to FIG. 2B, the configuration of the robot control device 6 will be described. As illustrated in FIG. 2B, the robot control device 6 has various functions such as a communication interface 60, a robot connection response unit 63, a robot connection determination unit 64, an input analysis unit 65, a robot program generation unit 66, and a robot operation control unit 67, which are implemented by the above hardware configuration.

The communication interface 60 is communicably connected to the communication interfaces 56_1, . . . , and 56_N of the numerical control devices 5_1, . . . , and 5_N, respectively, and can send and receive various information such as robot commands, connection requests, connection request information, disconnection requests, and connection approvals between the communication interface 60 and the communication interfaces 56_1, . . . , and 56_N.

The communication interface 60 includes a control area 61 and a connection request buffer 62 as a memory area for temporarily storing various information transmitted from communication interfaces 56_1, . . . , and 56_N.

When the communication interface 60 receives robot commands transmitted from the communication interfaces 56_1, . . . and 56_N, the communication interface 60 stores the robot commands in the control area 61. As mentioned above, the numerical control devices 5_1, . . . , and 5_N receive connection approvals transmitted from the robot control device 6 in response to the connection requests transmitted, and thereafter start transmitting robot commands, respectively. Therefore, the robot control device 6 can shift the timing to transmit the connection approvals to the numerical control devices 5_1, . . . , and 5_N, such that the timing is not overlapped with the timing to transmit the robot commands from the numerical control devices 5_1,., and 5_N. Thus, according to the present embodiment, the control area 61 for temporarily storing robot commands can be shared, so there is no need to increase the size of the control area 61 even if the number of numerical control devices connected to the robot control device 6 increases.

When the communication interface 60 receives the connection requests transmitted from the communication interfaces 56_1, . . . , and 56_N, the communication interface 60 stores the connection request information associated with the connection requests in the connection request buffer 62 in the order of receipt. As mentioned above, the connection request information includes identification information necessary for identifying the sender of the connection request on the robot control device 6 side, and a priority value (value specified based on the priority specification command or a predetermined initial value). When the communication interface 60 receives the disconnection requests transmitted from the communication interfaces 56_1, . . . , and 56_N, the communication interface 60 deletes the connection request information transmitted from the same sender of the disconnection request received, from among the plurality of connection request information stored in the connection request buffer 62.

The robot connection response unit 63 checks, at a predetermined cycle, whether connection request information is stored in the connection request buffer 62, and if the connection request information is stored, the robot connection response unit 63 reads the connection request information and transmits it to the robot connection determination unit 64. When a plurality of sets of connection request information are stored in the connection request buffer 62, the robot connection response unit 63 transmits all the connection request information stored in the connection request buffer 62 to the robot connection determination unit 64.

The robot connection determination unit 64 determines a connection approval transmission destination, based on the connection request information transmitted from the robot connection response unit 63, and transmits the connection approval transmission destination to the robot connection response unit 63.

Here, when only one set of connection request information is stored in the connection request buffer 62, the robot connection determination unit 64 identifies the sender of the connection request information, based on the identification information, and determines the sender as the connection approval transmission destination.

When a plurality of sets of connection request information are stored in the connection request buffer 62, the robot connection determination unit 64 identifies the senders of the connection request information, based on the identification information, and determines one of the senders as the connection approval transmission destination. Since the connection request information includes the priority values for the connection requests as mentioned above, the robot connection determination unit 64 determines one of the senders as the connection approval transmission destination, based on the priority values. More specifically, the robot connection determination unit 64 compares the priority values included in the connection request information, and determines the sender having the largest priority value (namely the highest priority) as the connection approval transmission destination. Note that if the priority values are the same, the robot connection determination unit 64 determines the sender of the connection request, which has been received earlier by the communication interface 60, as the connection approval transmission destination. If the smaller the priority value, the higher the priority as mentioned above, the robot connection determination unit 64 determines the sender having the smallest priority value as the connection approval transmission destination.

When the connection approval transmission destination is determined by the robot connection determination unit 64 through the process as described above, the robot connection response unit 63 generates a connection approval and transmits the connection approval to the communication interface of the connection approval transmission destination via the communication interface 60. As a result, the robot command generated based on the numerical control program is transmitted from the communication interface of the connection approval transmission destination to the communication interface 60.

The input analysis unit 65 reads and analyzes the robot command stored in the control area 61, and transmits the analysis result to the robot program generation unit 66.

The robot program generation unit 66 generates a robot program in accordance with the analysis result of the robot command transmitted from the input analysis unit 65. More specifically, when the robot command is inputted from the input analysis unit 65, the robot program generation unit 66 adds robot instructions for this robot command to the robot program stored in a storage unit (not illustrated).

The robot operation control unit 67 launches the robot program generated by the robot program generation unit 66, and sequentially executes the robot instructions described in the launched robot program, whereby controlling the operation of the robot 3. More specifically, the robot operation control unit 67 executes the robot instructions, thereby calculating the target positions of the control axes of the robot 3, performs feedback control of the servo motors of the robot 3 so as to achieve the calculated target positions, thereby generating robot control signals for the robot 3, and inputting the robot control signals to the servo motors of the robot 3.

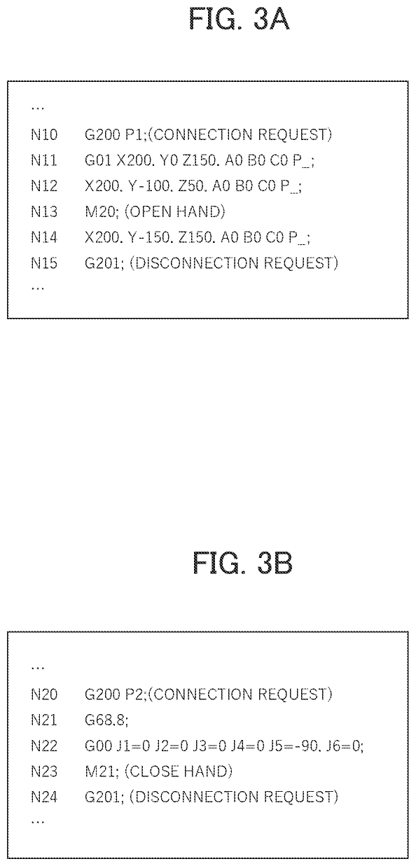

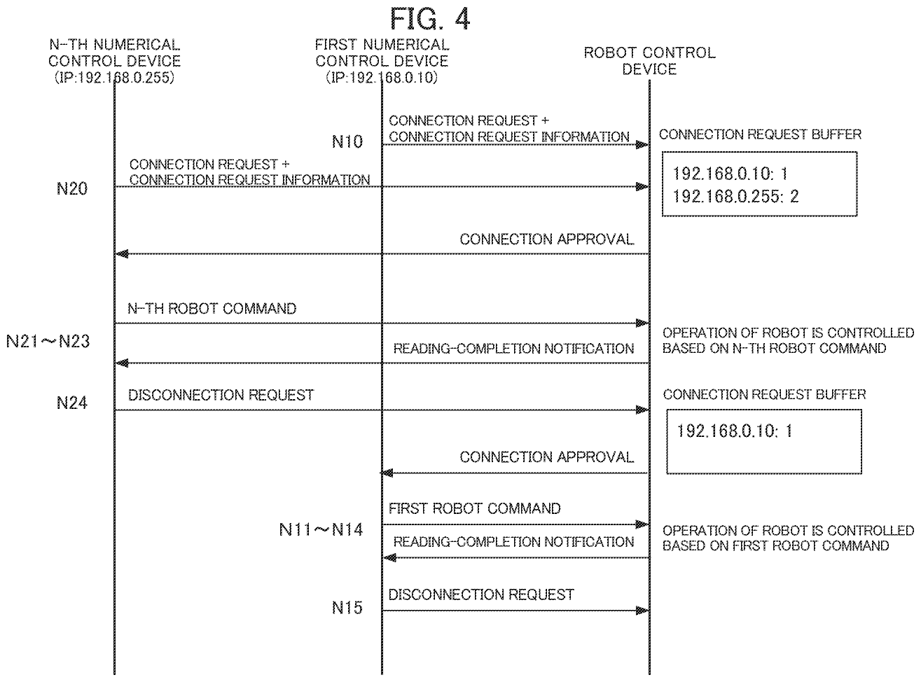

Next, referring to FIGS. 3A, 3B, and 4, the first example of the flow of various signals and information in the numerical control system 1 configured as described above will be described.

FIG. 3A is the first example of the first numerical control program, and FIG. 3B is the first example of the N-th numerical control program. Note that FIGS. 3A and 3B omit the illustration of the command blocks for the first and N-th machine tools, among the plurality of command blocks that configure the numerical control programs.

FIG. 4 is a sequence diagram illustrating the flow of signals and information between the first and N-th numerical control devices and the robot control device, when the first and N-th numerical control devices are operated based on the numerical control programs illustrated in FIGS. 3A and 3B.

At first, in the block indicated by the sequence number “N10”, a command “G200 P1”, which generates a connection request to the robot control device and specifies “1” as the priority value, is input to the robot connection request unit of the first numerical control device. In response, the robot connection request unit and the communication interface of the first numerical control device transmit the connection request and the connection request information to the communication interface of the robot control device. Here, the connection request information transmitted from the first numerical control device to the robot control device includes the IP address “192.168.0.10” unique to the first numerical control device, and the priority value “1”.

Next, in the block indicated by the sequence number “N20”, a command “G200 P2”, which generates a connection request to the robot control device and specifies “2” as the priority value, is input to the robot connection request unit of the N-th numerical control device. In response, the robot connection request unit and the communication interface of the N-th numerical control device transmit the connection request and the connection request information to the communication interface of the robot control device. Here, the connection request information transmitted from the N-th numerical control device to the robot control device includes the IP address “192.168.0.255” unique to the N-th numerical control device, and the priority value “2”.

On the other hand, in response to receiving the connection request and the connection request information from the first and N-th numerical control devices through the process as described above, the communication interface of the robot control device stores the received connection request information in the connection request buffer in the order of receipt. Thereafter, the robot connection determination unit of the robot control device determines the connection approval transmission destination, based on the two sets of connection request information stored in the connection request buffer. In the example illustrated in FIG. 4, the priority value of the connection request from the first numerical control device is “1”, and the priority value of the connection request from the N-th numerical control device is “2”. In other words, the priority of the connection request from the N-th numerical control device is higher than the priority of the connection request from the first numerical control device. Therefore, the robot connection determination unit determines the N-th numerical control device as the connection approval transmission destination. The robot connection response unit and the communication interface of the robot control device transmit the connection approval to the communication interface of the N-th numerical control device.

In response to confirming the receipt of the connection approval from the robot control device, the robot command generation unit of the N-th numerical control device sequentially reads the blocks indicated by “N21” to “N23”, and generates the N-th robot commands in accordance with the commands “N21” to “N23”; and the communication interface of the N-th numerical control device sequentially transmits the generated N-th robot commands to the robot control device. The robot control device controls the operation of the robot, based on the N-th robot command received, and transmits a reading-completion notification to the N-th numerical control device, in response to completion of reading the N-th robot command. While the operation of the robot is being controlled based on the N-th robot command transmitted from the N-th numerical control device in this manner, the first numerical control device with a lower priority will be in the state of waiting for a connection approval from the robot control device. Therefore, during this period, the first numerical control device does not need to actively check the operating status of the robot by communicating with the robot control device.

Next, in the block indicated by the sequence number “N24”, a command “G201”, which generates a disconnection request to the robot control device, is input to the robot connection request unit of the N-th numerical control device. In response, the robot connection request unit and the communication interface of the N-th numerical control device transmit a disconnection request to the communication interface of the robot control device. In response to receiving the disconnection request from the N-th numerical control device, the communication interface of the robot control device deletes the connection request information transmitted from the N-th numerical control device, from among the plurality of sets of connection request information stored in the connection request buffer. As a result, the connection request information stored in the connection request buffer will be only the connection request information transmitted from the first numerical control device.

Thereafter, the robot connection determination unit of the robot control device determines the first numerical control device, which is the sender of one set of connection request information stored in the connection request buffer, as the connection approval transmission destination. The robot connection response unit and the communication interface of the robot control device transmit the connection approval to the communication interface of the first numerical control device.

In response to confirming the receipt of the connection approval from the robot control device, the robot command generation unit of the first numerical control device sequentially reads the blocks indicated by “N11” to “N14”, and generates the first robot commands in accordance with the commands “N11” to “N14”; and the communication interface of the first numerical control device sequentially transmits the generated first robot commands to the robot control device. The robot control device controls the operation of the robot, based on the received first robot command, and transmits a reading-completion notification to the first numerical control device in response to completion of reading the first robot command.

Next, in the block indicated by the sequence number “N15”, a command “G201”, which generates a disconnection request to the robot control device, is input to the robot connection request unit of the first numerical control device. In response, the robot connection request unit and the communication interface of the first numerical control device transmit a disconnection request to the communication interface of the robot control device. In response to receiving the disconnection request from the first numerical control device, the communication interface of the robot control device deletes the connection request information transmitted from the first numerical control device, from among the connection request information stored in the connection request buffer.

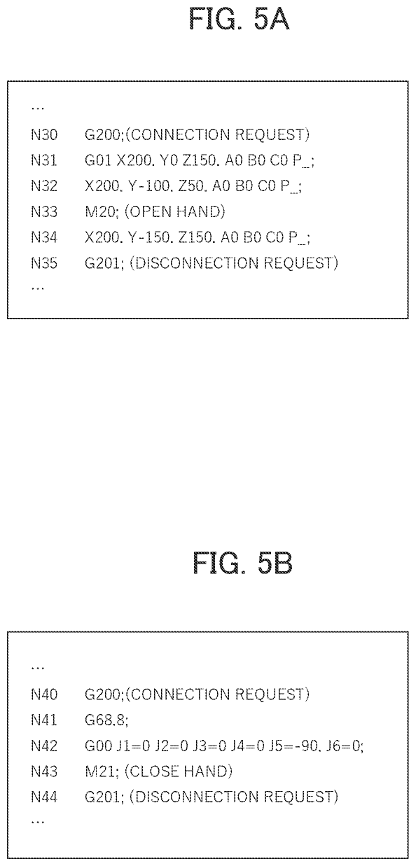

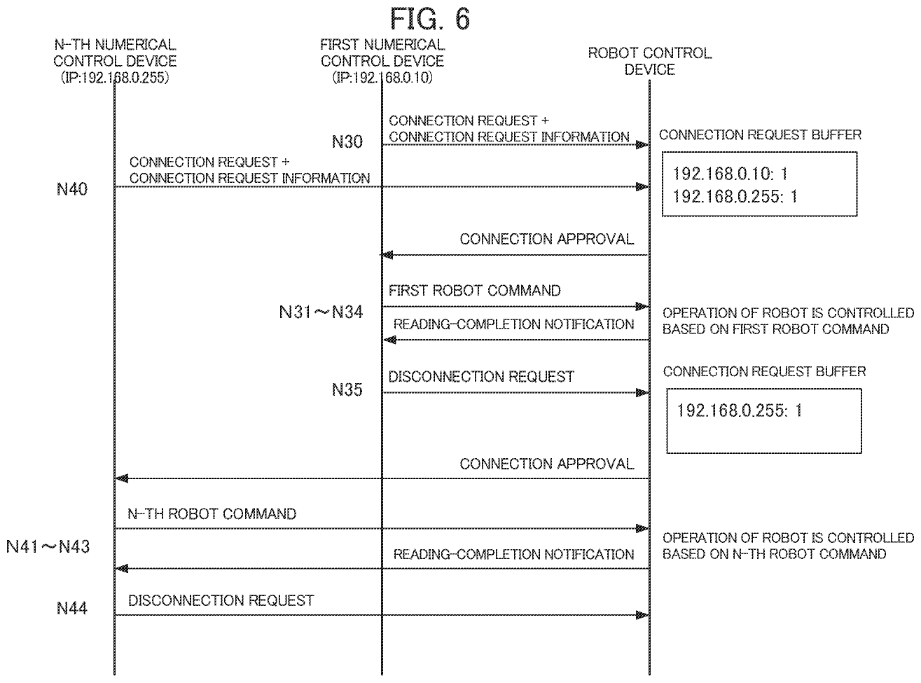

Next, referring to FIGS. 5A, 5B, and 6, the second example of the flow of various signals and information in the numerical control system 1, which is configured as described above, will be described.

FIG. 5A is the second example of the first numerical control program, and FIG. 5B is the second example of the N-th numerical control program. Note that the first numerical control program illustrated in FIG. 5A and the N-th numerical control program illustrated in FIG. 5B do not describe the priority specification command “P_”, which is the difference from the first numerical control program illustrated in FIG. 3A and the N-th numerical control program illustrated in FIG. 3B.

FIG. 6 is a sequence diagram illustrating the flow of signals and information between the first and N-th numerical control devices and the robot control device when the first and N-th numerical control devices are operated based on the numerical control programs illustrated in FIGS. 5A and 5B.

At first, in the block indicated by the sequence number “N30”, a command “G200”, which generates a connection request to the robot control device, is input to the robot connection request unit of the first numerical control device. In response, the robot connection request unit and the communication interface of the first numerical control device transmit the connection request and the connection request information to the communication interface of the robot control device. Here, when the priority value is not specified based on the first numerical control program, the robot connection request unit transmits a predetermined initial value (“1” in the example in FIG. 6) as the priority value to the robot control device.

Next, in the block indicated by the sequence number “N40”, a command “G200”, which generates a connection request to the robot control device, is input to the robot connection request unit of the N-th numerical control device. In response, the robot connection request unit and the communication interface of the N-th numerical control device transmit the connection request and the connection request information to the communication interface of the robot control device. Here, when the priority value is not specified based on the N-th numerical control program, the robot connection request unit transmits a predetermined initial value (“1” in the example in FIG. 6) as the priority value to the robot control device.

On the other hand, in response to receiving the connection request and the connection request information from the first and N-th numerical control devices through the process as described above, the communication interface of the robot control device stores the received connection request information in the connection request buffer in the order of receipt. Thereafter, the robot connection determination unit of the robot control device determines the connection approval transmission destination, based on the two sets of connection request information stored in the connection request buffer. In the example illustrated in FIG. 6, the priority value of the connection request from the first numerical control device is “1”, and the priority value of the connection request from the N-th numerical control device is also “1”. In other words, the priority is the same for the first numerical control device and the N-th numerical control device. In this case, the robot connection determination unit determines the first numerical control device, from which the connection request has been received earlier, as the connection approval transmission destination. Therefore, the robot connection response unit and the communication interface of the robot control device transmit the connection approval to the communication interface of the first numerical control device. Note that the flow after this is almost the same as the example illustrated in FIG. 4, except that the order of transmitting the connection approval from the robot control device is reversed, so the detailed description is omitted.

Next, referring to FIGS. 7A, 7B, and 8, the third example of the flow of various signals and information in the numerical control system 1, which is configured as described above, will be described.

FIG. 7A is the third example of the first numerical control program, and FIG. 7B is the third example of the N-th numerical control program. Note that, in the first numerical control program illustrated in FIG. 7A, the priority value specified based on the priority specification command “P_” is different from that in the first numerical control program illustrated in FIG. 3A. The N-th numerical control program illustrated in FIG. 7B does not describe the priority specification command “P_”, which is the difference from the N-th numerical control program illustrated in FIG. 3B.

FIG. 8 is a sequence diagram illustrating the flow of signals and information between the first and N-th numerical control devices and the robot control device when the first and N-th numerical control devices are operated based on the numerical control programs illustrated in FIGS. 7A and 7B.

At first, in the block indicated by the sequence number “N50”, a command “G200 P3”, which generates a connection request to the robot control device and specifies “3” as the priority value, is input to the robot connection request unit of the first numerical control device. In response, the robot connection request unit and the communication interface of the first numerical control device transmit the connection request and the connection request information to the communication interface of the robot control device. Here, the connection request information transmitted from the first numerical control device to the robot control device includes the IP address “192.168.0.10” unique to the first numerical control device, and the priority value “3”.

Next, in the block indicated by the sequence number “N60”, a command “G200”, which generates a connection request to the robot control device, is input to the robot connection request unit of the N-th numerical control device. In response, the robot connection request unit and the communication interface of the N-th numerical control device transmit the connection request and the connection request information to the communication interface of the robot control device. FIG. 6 describes the example in which, when a priority value is not specified based on the N-th numerical control program, a predetermined initial value is transmitted as the priority value to the robot control device; however, the present disclosure is not limited to this. As illustrated in FIG. 8, when a priority value is not specified based on the N-th numerical control program, the robot connection request unit and the communication interface may transmit only the identification information to the robot control device without transmitting a priority value.

On the other hand, in response to receiving the connection request and the connection request information from the first and N-th numerical control devices through the process as described above, the communication interface of the robot control device stores the received connection information in the connection request buffer in the order of receipt. In this case, as mentioned above, the connection request information transmitted from the N-th numerical control device does not include a priority value. Therefore, among the two sets of connection request information stored in the connection request buffer, the priority value of the connection request information transmitted from the N-th numerical control device will be blank, as illustrated in FIG. 8.

Thereafter, the robot connection determination unit of the robot control device determines the connection approval transmission destination, based on the two sets of connection request information stored in the connection request buffer. Here, when a priority value is not included in the connection request information stored in the connection request buffer, the robot connection determination unit determines the connection approval transmission destination, based on the predetermined initial value (“1” for example). Therefore, in the example illustrated in FIG. 8, the robot connection determination unit sets the priority value of the connection request from the first numerical control device to “3” specified based on the numerical control program, sets the priority value of the connection request from the N-th numerical control device to the initial value “1”, and determines the connection approval transmission destination. Therefore, the robot connection determination unit determines the first numerical control device, which has a higher priority, as the connection approval transmission destination. Therefore, the robot connection response unit and the communication interface of the robot control device transmit the connection approval to the communication interface of the first numerical control device. Note that the flow after this is almost the same as the example illustrated in FIG. 6, so the detailed description is omitted.

The following effects are achieved according to the present embodiment. According to the present embodiment, if the operator is familiar with the numerical control program used for controlling the machine tools 2_1, . . . and 2_N, the operator can also control the robot 3 without having to become proficient in the robot program described in a language different from the language of the numerical control program. According to the present embodiment, the communication interfaces 56_1, . . . , and 56_N of the numerical control devices 5_1, . . . , and 5_N receive the connection approval generated by the robot connection response unit 63 of the robot control device 6 in response to the connection requests generated by the robot connection request units 55_1, . . . , and 55_N of the numerical control devices 5_1, . . . , and 5_N, respectively, and thereafter start transmitting the first to N-th robot commands to the communication interface 60 of the robot control device 6. In other words, the timing to start transmitting the robot commands from the numerical control devices 5_1, . . . , and 5_N to the robot control device 6 side can be managed on the robot control device 6 side in accordance with the connection requests transmitted from the numerical control devices 5_1, . . . , and 5_N. Therefore, according to the present embodiment, the control area 61 of the single communication interface 60 provided in the robot control device 6 can be shared to allow the robot commands to be received from the plurality of communication interfaces 56_1, . . . , and 56_N. Therefore, according to the present embodiment, the number of numerical control devices connected to the robot control device 6 and the number of their control modules can be changed regardless of the size of the control area 61 of the communication interface 60 of the robot control device 6. According to the present embodiment, for example, while the robot control device 6 is controlling the operation of the robot 3, based on the robot commands transmitted from a certain numerical control device, other numerical control devices no longer need to constantly check whether the operation of the robot 3 is completed, through communication; therefore, even if the number of connected numerical control devices increases, the communication load on the robot control device 6 will not increase, allowing for preventing the operational performance of the robot 3 from decreasing.

In the present embodiment, the robot control device 6 includes the robot connection determination unit 64 that determines one of the N numerical control devices 5_1, . . . , and 5_N as the connection approval transmission destination; and the robot connection response unit 63 and the communication interface 60 transmit a connection approval to the connection approval transmission destination determined by the robot connection determination unit 64. Thus, according to the present embodiment, a connection approval is transmitted to only one of the N numerical control devices 5_1, . . . , and 5_N, which is determined as the connection approval transmission destination; and the control area 61 of the communication interface 60 receives only the robot commands from this connection approval transmission destination, whereby allowing for sharing the control area 61 of the communication interface 60 by the plurality of numerical control devices 5_1, . . . , and 5_N.

In the present embodiment, the robot connection request units 55_1,, and 55_N of the respective numerical control devices 5_1, . . . , and 5_N generate a connection request to the robot control device 6, based on the numerical control program. As a result, a connection request to the robot control device 6 can be generated at an appropriate timing that is set by the operator considering the overall system cycle time.

In the present embodiment, the robot control device 6 further includes the connection request buffer 62 that stores the connection request information associated with the connection request received by the communication interface 60; and the robot connection determination unit 64 determines the connection approval transmission destination, based on the connection request information stored in the connection request buffer 62. According to the present embodiment, a plurality of sets of connection request information transmitted from the numerical control devices 5_1, . . . , and 5_N are accumulated in the connection request buffer 62; and the robot connection determination unit 64 can determine the connection approval transmission destination at any timing.

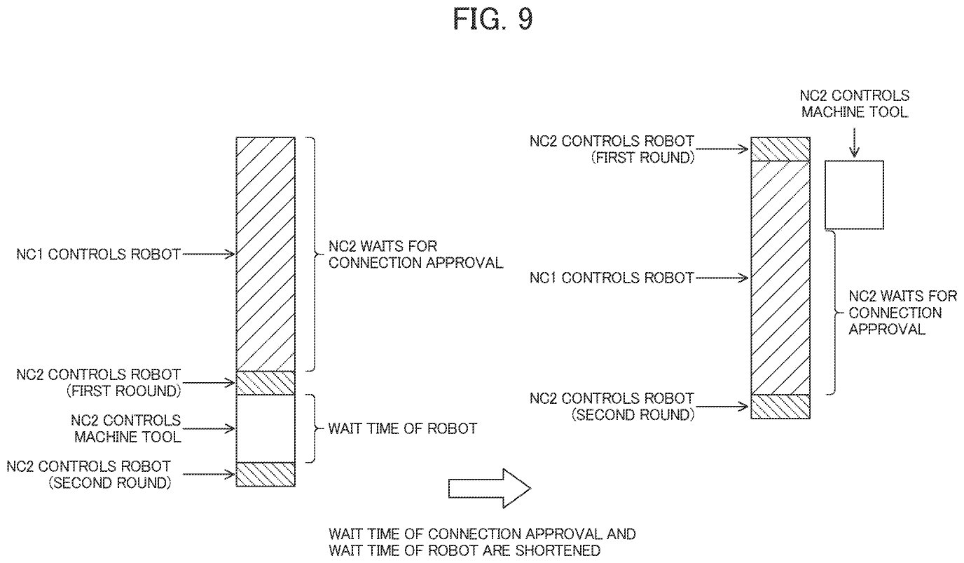

In the present embodiment, the connection request information that is stored in the connection request buffer 62 includes identification information for identifying the sender of the connection request, and the priority value of the connection request, in which the priority value can be specified by the priority specification command “P_”, based on the numerical control program. In the present embodiment, when a plurality of sets of connection request information are stored in the connection request buffer 62, the robot connection determination unit 64 determines the connection approval transmission destination, based on the priority values thereof. As a result, the robot control device 6 can transmit connection approvals in the appropriate order as determined by the operator to minimize the overall system cycle time as much as possible. Here, the effects by setting priorities for connection requests from the numerical control devices 5_1, . . . , and 5_N will be described with reference to FIG. 9.

FIG. 9 is a diagram comparing the overall system cycle times by changing the priority settings in the case where two numerical control devices are connected to one robot control device. In the example in FIG. 9, the cycle time of the first numerical control device (referred to as “NC1” in FIG. 9) is set to be longer than the cycle time of the second numerical control device (referred to as “NC2” in FIG. 9). Therefore, the frequency of the second numerical control device to control the operation of the robot through the robot control device is higher than the frequency of the first numerical control device to control the operation of the robot through the robot control device.

The left graph in FIG. 9 illustrates the overall system cycle time when the connection approvals are transmitted in the order of receipt, without specifying the priority values for the connection requests transmitted from the two numerical control devices to the robot control device. The right graph in FIG. 9 illustrates the overall system cycle time in the case where the priority of the connection requests from the second numerical control device having a shorter cycle time is set higher than the priority of the connection requests from the first numerical control device having a longer cycle time.

As illustrated in the left graph in FIG. 9, when connection approvals are transmitted in the order of receipt, there may be cases where a connection approval is transmitted first to the first numerical control device, which has a longer cycle time than that of the second numerical control device. In this case, as illustrated in the left graph in FIG. 9, while the first numerical control device is controlling the robot, namely while the first numerical control device is occupying the control area of the communication interface of the robot control device, the second numerical control device is in a state of waiting for a connection approval from the robot control device. In this case, as illustrated in the left graph in FIG. 9, once the first numerical control device finishes controlling the robot, the second numerical control device starts controlling the robot in the first round. However, since the second numerical control device has a shorter cycle time than the first numerical control device, there may be cases where the robot is in a standby state during the period from the end of the first round until the start of the second round of controlling the robot by the second numerical control device, namely while the second numerical control device is controlling the second machine tool. Such a standby state of the robot may occur, for example, in a situation where the robot attaches or removes a workpiece to or from a machine tool, and waits for the machine tool to finish machining the workpiece.

On the other hand, as illustrated in the right graph in FIG. 9, when the priority of the connection request from the second numerical control device, which has a relatively short cycle time, is set higher than that of the first numerical control device, after the second numerical control device finishes the first round of controlling the robot, the second machine tool can be controlled in parallel with the control of the robot by the first numerical control device. Therefore, the time that the second numerical control device waits for a connection approval from the robot control device can be shorter than the example in the left graph in FIG. 9. In this case, the second round of controlling the robot by the second numerical control device can start immediately after the first numerical control device finishes controlling the robot; therefore, the standby time of the robot can also be made shorter than the example in the left graph in FIG. 9.

As described above, in the present embodiment, the operator can specify the priority values for the connection requests from the numerical control devices 5_1, . . . , and 5_N, respectively, such that the overall system cycle time can be as short as possible in accordance with the cycle times of the numerical control devices 5_1, . . . , and 5_N.

In the present embodiment, when a priority value for the connection request is not specified in the numerical control program, the robot connection request units 55_1, . . . , and 55_N of the numerical control devices 5_1, . . . , and 5_N transmit predetermined initial values as the priority values to the robot control device 6, respectively. According to the present embodiment, even if the operator forgets to specify a priority value when creating the numerical control program, the numerical control system 1 can be operated under the predetermined initial value, which is convenient.

In the present embodiment, when the connection request information stored in the connection request buffer 62 does not include a priority value, the robot connection determination unit 64 determines the connection approval transmission destination, based on a predetermined initial value. According to the present embodiment, even if the operator forgets to specify a priority value when creating the numerical control program, the numerical control system 1 can be operated under the predetermined initial value, which is convenient.

### Second Embodiment

Referring to the drawings, the numerical control system according to the second embodiment of the present disclosure will be described below.

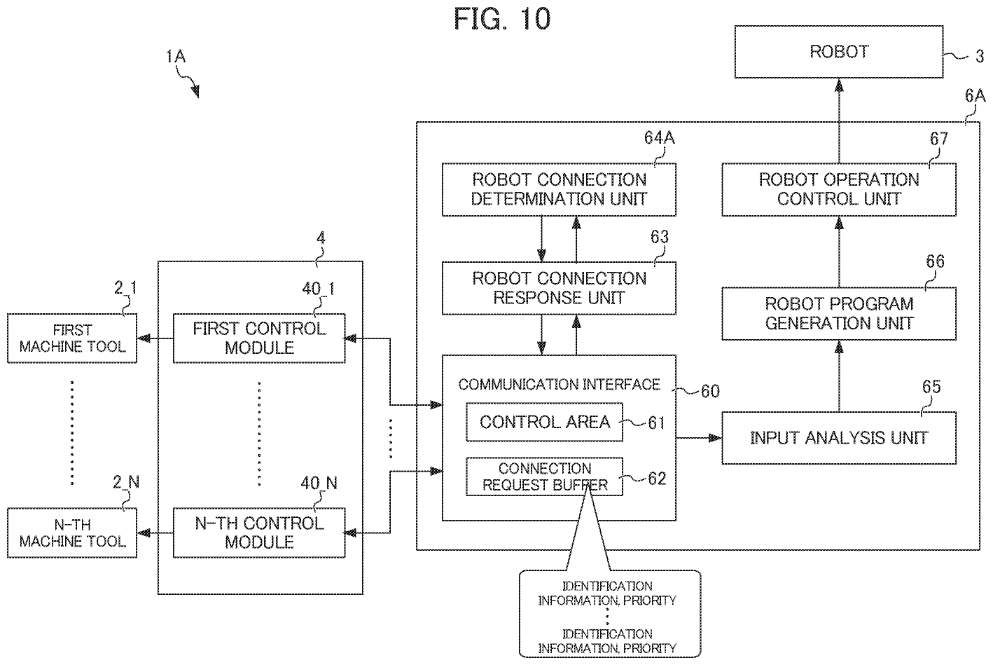

FIG. 10 is a functional block diagram of the numerical control system 1A according to the present embodiment. In the following description of the numerical control system 1A, the same numerals are used for the same configurations as those of the numerical control system 1 according to the first embodiment, and the detailed description is omitted.

The numerical control system 1A includes: a plurality of machine tools 2_1, . . . , and 2_N (N units, where N is an integer equal to or greater than 2 in the present embodiment); a single numerical control device 4 that controls the operation of the machine tools 2_1, . . . , and 2_N; a robot 3 provided near the machine tools 2_1, . . . , and 2_N; and a robot control device 6A that is communicably connected to the numerical control device 4.

The numerical control device 4 and the robot control device 6A are computers, which are configured with hardware such as: arithmetic processing means such as CPU (Central Processing Unit); auxiliary storage means such as HDD (Hard Disk Drive) or SSD (Solid State Drive) for storing various programs; main storage means such as RAM (Random Access Memory) for storing data temporarily required when the arithmetic processing means executes the programs; operation means such as a keyboard for the operator to perform various operations; and display means such as a display for displaying various information for the operator. The robot control device 6A and the numerical control device 4 can send and receive various signals to and from each other, for example, via Ethernet (registered trademark).

As illustrated in FIG. 10, the numerical control device 4 includes various functions such as N control modules 40_1, . . . , and 40_N serving as the control systems for the machine tools 2_1, . . . , and 2_N, respectively, and the robot 3, which are implemented by the above-mentioned hardware configuration.

Each of the control modules 40_1, . . . , and 40 N includes a program storage unit, a program input unit, an input analysis unit, a machine tool control unit, a robot command generation unit, a robot connection request unit, and a communication interface, all of which have almost the same configuration of the first numerical control device 5_1 according to the first embodiment. The communication interfaces of the control modules 40_1, . . . , and 40_N are communicably connected to the communication interface 60 of the robot control device 6A. The connection request information transmitted from the robot connection request unit and the communication interfaces of the control modules 40_1, . . . , and 40_N includes, as identification information for identifying a sender of a connection request, the IP address unique to the numerical control device 4, and the module numbers assigned to the control modules 40_1, . . . , and 40_N, respectively.

The robot control device 6A includes the communication interface 60, the control area 61, the connection request buffer 62, the robot connection response unit 63, the robot connection determination unit 64A, the input analysis unit 65, the robot program generation unit 66, and the robot operation control unit 67.

The robot connection determination unit 64A determines one of the control modules 40_1, . . . , and 40_N as the connection approval transmission destination, based on the connection request information transmitted from the robot connection response unit 63, and transmits the connection approval transmission destination to the robot connection response unit 63. Note that the specific process by the robot connection determination unit 64A to determine the connection approval transmission destination based on the connection request information is almost the same as the process by the robot connection determination unit 64 according to the first embodiment, so the detailed description is omitted.

The present embodiment achieves almost the same effects as achieved by the numerical control system 1 according to the first embodiment.

One embodiment of the present disclosure has been described above; however, the present disclosure is not limited thereto. The detailed configurations may be changed as appropriate within the scope of the present disclosure.

### EXPLANATION OF REFERENCE NUMERALS

1, 1a . . . numerical control system

2 1, 2_n . . . machine tool

3 . . . robot

4, 5_1, 5_n . . . numerical control device

40_1, 40_n, 50_1, 50_n . . . control module

51_1, 51_n . . . program input unit

52_1, 52_n . . . input analysis unit

53_1, 53_n . . . machine tool control unit

54_1, 54_n . . . robot command generation unit

55_1, 55_n . . . robot connection request unit

56_1, 56_n . . . communication interface

59_1, 59_n . . . program storage unit

6, 6a . . . robot control device

60 . . . communication interface

61 . . . control area

62 . . . connection request buffer

63 . . . robot connection response unit

64, 64a . . . robot connection determination unit

65 . . . input analysis unit

66 . . . robot program generation unit

67 . . . robot operation control unit

1. A numerical control system, comprising:
a numerical control device that controls an operation of a machine tool, based on a numerical control program; and
a robot control device that controls an operation of a robot, based on a robot command,
wherein the numerical control device includes one or more control modules that generate the robot command, based on the numerical control program,
wherein the control modules each include:
a robot command generation unit that generates the robot command, based on the numerical control program;
a robot connection request unit that generates a connection request to the robot control device; and
a command-transmitting communication interface that transmits the connection request and the robot command to the robot control device,
wherein the robot control device includes:
a command-receiving communication interface that receives the connection request and the robot command;
a robot operation control unit that controls the operation of the robot, based on the robot command; and
a robot connection response unit that generates a connection approval for the connection request after the connection request is received by the command-receiving communication interface,
wherein the command-receiving communication interface transmits the connection approval to the command-transmitting communication interface, and
wherein the command-transmitting communication interface starts transmission of the robot command to the command-receiving communication interface after receiving the connection approval.

2. The numerical control system according to claim 1, wherein the numerical control system includes two or more of the numerical control devices each communicably connected to the robot control device,
wherein the robot control device further includes a robot connection determination unit that determines any one of a plurality of the numerical control devices as a transmission destination for the connection approval, and
wherein the command-receiving communication interface transmits the connection approval to the transmission destination.

3. The numerical control system according to claim 1, wherein the numerical control device includes two or more of the control modules each communicably connected to the robot control device,
wherein the robot control device further includes a robot connection determination unit that determines any one of the plurality of control modules as a transmission destination for the connection approval, and
wherein the command-receiving communication interface transmits the connection approval to the transmission destination.

4. The numerical control system according to claim 2 or 3, wherein the robot connection request unit generates the connection request, based on the numerical control program.

5. The numerical control system according to claim 4, wherein the robot control device further includes a connection request buffer that stores connection request information associated with the connection request received by the command-receiving communication interface, and
wherein the robot connection determination unit determines the transmission destination, based on the connection request information.

6. The numerical control system according to claim 5, wherein the connection request information includes identification information for identifying a sender of the connection request, and a priority value, and
wherein the priority value can be specified based on the numerical control program.

7. The numerical control system according to claim 6, wherein the robot connection determination unit determines the transmission destination, based on the priority value, when a plurality of the connection request information is stored in the connection request buffer.

8. The numerical control system according to claim 7, wherein a predetermined initial value is stored as the priority value in the connection request buffer, when the priority value is not specified in the numerical control program.

9. The numerical control system according to claim 7, wherein the robot connection determination unit determines the transmission destination, based on a predetermined initial value, when the connection request information does not include the priority value.
